(19) United States
(12) Patent Application Publication
(10) Pub. No.: US 2008/0308033 A1
(43) Pub. Date: Dec. 18, 2008

(54) MEDICATION REMINDER AND TRACKING DEVICES

(76) Inventor: Angelo Cirrincione, Glendale, CA (US)

Correspondence Address: LAW OFFICES OF JOSEPH R. CRUSE, JR., 28215 AGOURA ROAD, SUITE 130, AGOURA HILLS, CA, 91301, US

(21) Appl. No.: 11/764,636

(22) Filed: Jun. 18, 2007

(51) Int. Cl. G09F 9/40

(52) U.S. Cl. 116/321

(57) ABSTRACT

A reminder and tracking device for medication capable of tracking medication usage which comprises a set of numbers and letters on a plane with indicators which is attached directly to the medication along the bottle's neck reducing the chance of the person being improperly medicated.

### FIELD OF THE INVENTION

The present invention relates to the medical and prescription drug industries, and more particularly relates to a device for tracking medication usage from a bottle of pills, medicine or similar type of medication dispensing device.

### BACKGROUND OF THE INVENTION

Individuals are constantly striving to remember the drugs they have taken or are supposed to take on a daily basis. Unfortunately, this results in numerous incidences of improper medication. Doctors prescribe million of medical prescriptions each day. Individuals are trusted and released into their own care with instructions from the health care providers to take their medications at certain times.

Often an individual will be left thinking whether they have indeed taken their medication that morning, evening or day. The individual will then be left to make a choice to either (1) take the medication or (2) not take the medication. The incorrect choice results in an improper dosage of either too little or too much.

Such scenarios occur with millions of people. Some doctors even prescribe outside nursing staff to ensure the patient is taking the correct dosage. Others will recommend that the patient be sent to a facility for assisted living or a nursing home, so that the medical staff can supervise the dosage.

In sum, the consequences of improper medication and dosage caused by the failure of a patient to remember correctly whether they took their medicine, are harmful in many ways and can often times lead to serious health consequences, including death.

Therefore, a need exists for a device that assists a patient in reminding them whether or not they have taken their medication.

### BACKGROUND OF THE INVENTION—OBJECTS AND ADVANTAGES

Accordingly, besides the objects and advantages of the Medication Reminder and Tracking Device described herein, several objects and advantages of the present invention are:
a) The present invention solves the above and other needs by securing a device to a prescription bottle containing medication in any form such as pills or liquid.
b) An embodiment of the present invention secures the reminder device to a bottle of medicine by wrapping an elastic band attached to the device around the neck of the bottle. The device can also be attached to the bottle by using a common adhesive, such as double-sided tape. The bottle of medicine may contain pills or liquid, or any other type of similar medication.
c) The reminder device may be constructed in whole or in part of molded or extruded plastic or any other similar material known to those of ordinary skill in the art.
d) The reminder device may contain one or more sliding view finders or indicators which assists to more easily track the medication taken according to days, number of pills, amount or any other desired variable.
e) The reminder device may contain notches to keep the sliding view finders or indicators in place.

Still further objects and advantages will become apparent from a consideration of the ensuing description and drawing.

### SUMMARY

In accordance with the present invention, a device that is capable of reminding a patient whether they have taken their medication.

### DRAWINGS—FIGURES

The above and other aspects of the present invention will be more apparent from the following more particular description thereof, presented in conjunction with the following drawings wherein:

FIG. 1A is a front view of an embodiment of the present invention utilizing two sling windows on opposing sides;

FIG. 1B is a front view of the present invention secured to the neck of a bottle of medication, such as a bottle of prescription pills;

FIG. 2 is a front view of an embodiment of the present invention showing notches and grooves along, the sides;

FIG. 3A is a front view of an embodiment of the present invention utilizing one sliding window and an arrow indicator;

FIG. 3B is a front view of the elastic band with adjustable ring

FIG. 3C is a front view of an embodiment of the present invention utilizing one sliding window and an arrow indicator, secured to the neck of a bottle of medication, such as a bottle of prescription pills; and

FIG. 4 is a front view of an embodiment of the present invention utilizing one sliding window and an arrow indicator showing notches and grooves along the sides;

### DETAILED DESCRIPTION

The following detailed description is of the best mode presently contemplated for carrying out the invention. This description is not to be taken in a limiting sense, but is made merely for the purpose of describing the general principles of the invention.

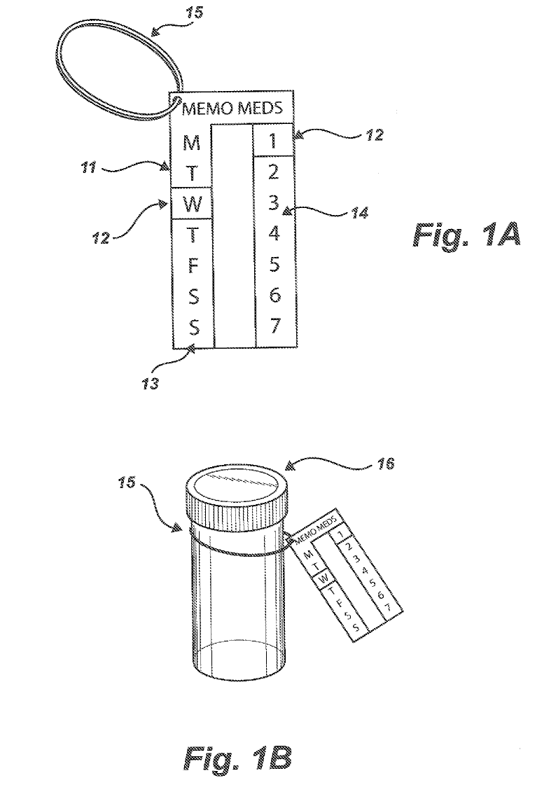

FIG. 1A shows a front view of an embodiment of the present invention. As shown in FIG. 1A, an embodiment of the present invention includes a rigid plane (11) of molded and formed material such as plastic. The plane (11) may also be constructed in whole or in part of one of, or a combination of, the following materials: rubber, plastic, silicone, or any material known to those of ordinary skill in the art.

The embodiment of FIG. 1A includes a flat smooth surface on one side of the plane (11) so as to permit the sliding view finders (12) to be secured to the fixed surface of the plane. For example, the sliding view finders (12) may secure via the flat smooth surface of the plane (11) by frictional contact around the side of the plane 11. The plane (11) may possess letters (13) on one side of the front surface of the plane (11) indicating days of the week and numbers (14) on the opposing side of the front surface of the plane (11) indicating number of pills taken. Alternatively, the front side may possess an indicator on the front side of the plane (11) for morning, afternoon or evening. An elastic band (15) is attached to the rigid plane (11).

FIG. 1B displays an embodiment of the present invention with the elastic band (15) wrapped around and secured to a bottle of medication (16).

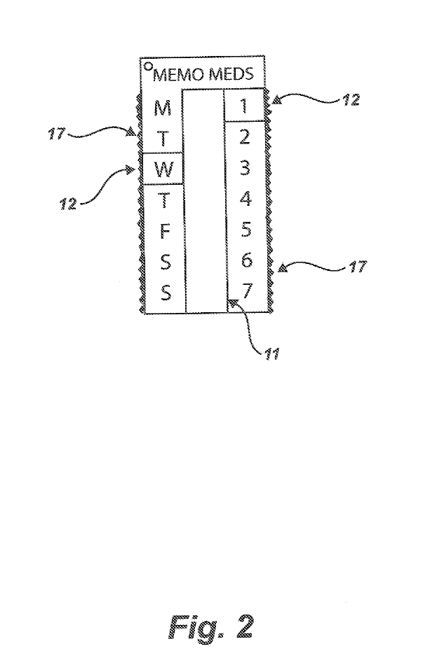

FIG. 2 shows a detailed front view of an embodiment of the present invention displaying stop notches (17) along the side of the plane (11). The notches (17) frictionally stop the view finders (12) at their intended position indicating the day of the week, number, or time of day.

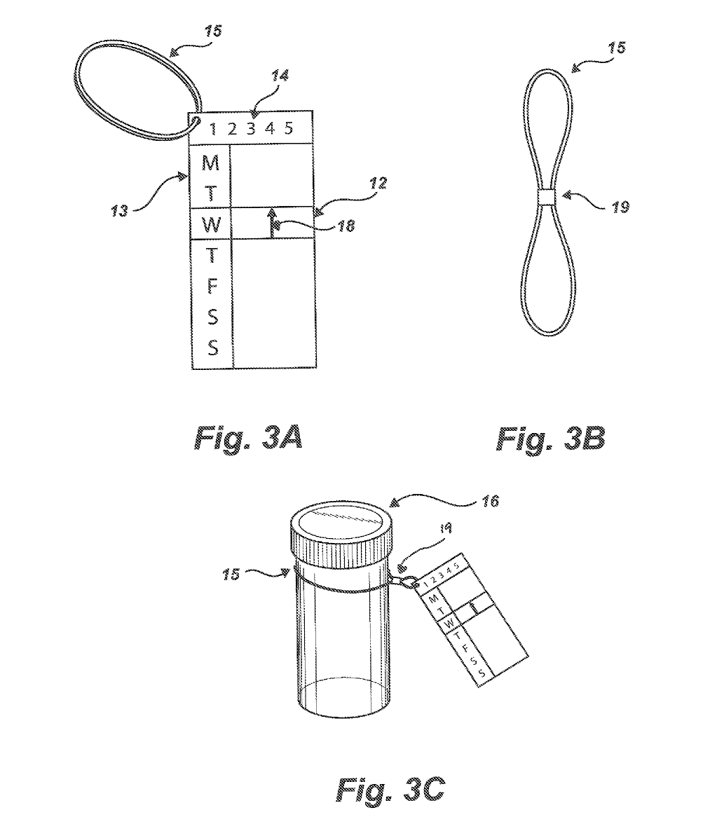

FIG. 3A shows a front view of an alternative embodiment of the present invention possessing an indicator arrow (18) located within the view finder (12). The arrow (18) may indicate the amount of medication to be taken or the time of day by pointing to a position located along the top front portion of the plane, while the sliding viewfinder (12) slides along the side of the plane (11) indicating the day of the week.

FIG. 3B shows an embodiment of the elastic band (15) fitted with a small adjustment ring (19) in which the elastic band (15) is passed through to permit adjustment of the elastic band (15) to be fitted around the neck of the bottle of medication (16).

FIG. 3C displays an embodiment of the present invention with the elastic band (15) fitted with the adjustment ring (19) wrapped around and secured to a bottle of medication (16).

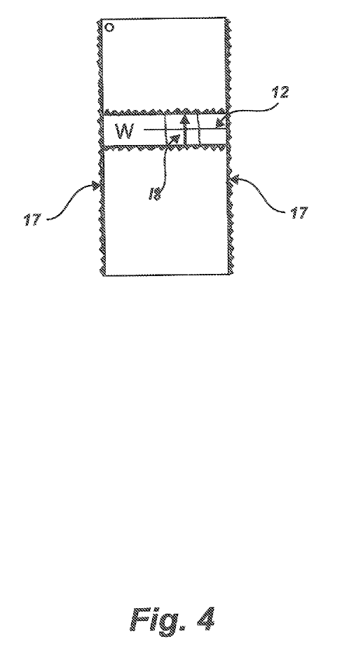

FIG. 4 shows a detailed front view of an embodiment of the present invention displaying stop notches (17) along the side of the plane (11). The notches (17) frictionally stop the view finder (12) at its intended position along the side of the plane (11) indicating the day of the week, number, or time of day. Stop notches (17) are also contained on the top and bottom of the view finder (12) in order to frictionally stop the arrow indicator (18) in its intended position.

I claim:

1. A device for use on a bottle of medication or for a similar container, said device comprising:
a rigid plane,
said plane made of plastic or similar material,
said plane is rectangular or square in shape,
said plane containing letters or numbers indicating days of the week along one side of the front side of the plane,
said plane containing letters or numbers on the opposing front side of the plane indicating the quantity of medication or time of day,
said plane containing a plurality of movable sleeves,
said movable sleeves possessing an open space in which to view the letters or numbers,
said plane possessing notches along the sides of said plane to frictionally stop said movable sleeve at their intended position along the side of said plane,

2. a plane as in claim 1, wherein said plane possesses a single movable sleeve,
said singular movable sleeve moving along the length of said plane from the top portion to the bottom portion of said plane,
said singular movable sleeve possessing an opening along the front of said plane
said plane possessing letters along the front side of its length,
said plane also possessing numbers along the front side of the top of said plane,
said opening on said singular movable sleeve positioned so as to permit the letter indicating the day of the week to be displayed within,
said plane containing notches along the length of its sides,
said notches frictionally contacting the said singular movable sleeve causing said singular movable sleeve to be stopped at its proper indicating position,
said singular movable sleeve possessing an indicating device,
said indicating device containing an arrow or triangle or similar symbol,
said indicating device moving along the horizontal length of the singular movable sleeve,
said singular movable sleeve possessing notches along its upper and lower sides,
said notches frictionally contacting said indicating device causing said indicating device to be stopped at its proper indicating position corresponding to said numbers along the top front side of said plane,

3. A plane as in claim 1, wherein said plane possesses an adhesive,
Said adhesive placed on the back side of said plane, opposite the letters and numbers to enable said plane to be secured to said bottle of medication.

4. A plane as in claim 1, wherein said plane possesses a small hole,
Said hole being a means to loop an elastic band through so as to attach said elastic band to said plane,
Said elastic band possessing a length such that it is adapted to extend over and be wrapped around the neck of a medication bottle;
wherein said elastic band is circular and closed;
wherein said elastic band is adapted to be wrapped around the neck of a medication bottle, so that the elastic band is in frictional contact with the neck so that when said band is extended and applied thereover, said band will constrict and remain on said bottle;

5. An elastic band as in claim 4, wherein said band possesses a small hollow ring,
said band possessing a closed small ring loop surrounding it so as to adjust the diameter of elastic band,
Said ring moving along the length of said elastic band so as to adjust said elastic band to be securely fitted around the neck of a bottle of medication.
